(19) United States
(12) Patent Application Publication
(10) Pub. No.: US 2024/0378438 A1
(43) Pub. Date: Nov. 14, 2024

(54) TRAINING A NEURAL NETWORK SYSTEM TO PREDICT THE BEHAVIOR OF INTERACTING AGENTS

(71) Applicant: Robert Bosch GmbH, Stuttgart (DE)

(72) Inventors: Eitan Kosman, Haifa (IL); Avinash Kumar, Bangalore (IN); Barbara Rakitsch, Stuttgart (DE); Gonca Guersun, Stuttgart (DE); Joerg Wagner, Renningen (DE); Yu Yao, Herzogenrath (DE)

(21) Appl. No.: 18/631,364

(22) Filed: Apr. 10, 2024

(30) Foreign Application Priority Data
May 11, 2023 (DE) 10 2023 204 389.0

(51) Int. Cl. G06N 3/08; G06N 3/0455

(52) U.S. Cl. CPC G06N 3/08; G06N 3/0455

(57) ABSTRACT

A method for training a neural network system to predict the behavior of a set of interacting agents. The method includes: providing training records of input data regarding each agent; generating, from each training record, by the encoder, agent representations; processing the agent representations into predicted behavior data regarding each agent; determining, from the agent representations, masked agent representations by modifying, in agent representations for at least two chosen agents, only respective strict subsets of the values of each agent representation; processing, by the to-be-trained GNN, the masked agent representations into interaction representations; determining, by a to-be-trained helper network, from the interaction representations, reconstructions of the agent representations; rating, using a predetermined loss function, the predicted behavior data, and a deviation of the reconstructions from the agent representations; and optimizing parameters that characterize the behavior of the GNN and that characterize the behavior of the helper network.

### CROSS REFERENCE

The present application claims the benefit under 35 U.S.C. § 119 of German Patent Application No. DE 10 2023 204 389.0 filed on May 11, 2023, which is expressly incorporated herein by reference in its entirety.

### FIELD

The present invention relates to the training of neural network systems to predict the behavior of a plurality of interacting agents, such as vehicles or robots in a traffic situation.

### BACKGROUND INFORMATION

In autonomous driving and driving assistance applications, one main task is to predict the behavior of the different drivers. For a given vehicle, such prediction requires a probabilistic inference framework that takes a set of measurements (velocity, relative position with respect to lanes etc.). Then, the framework solves a problem and outputs the prediction for each driver in a future time step. Finally, the prediction output is used in downstream autonomous driving or driving assistance functions, such as adaptive cruise control to improve driving comfort.

When machine learning models are trained to such a task, they are expected to learn natural behaviors and traffic rules solely from recorded training data. For example, the future trajectory of a vehicle should follow marked lanes. Also, future trajectories of two vehicles should not intersect, which would imply a collision. That is, a good prediction also depends on interactions between traffic participants. Graph neural networks, GNNs, are well suited to model such interactions.

However, it is difficult to actually force the GNN to rely on interactions. When only faced with the optimization goal that relates to the to-be-solved task, the GNN may just neglect the interactions as long as it can arrive at a satisfactory solution without considering interactions. So-called regularization methods modify the optimization goal such that it encourages considering interactions.

### SUMMARY

The present invention provides a method for training a neural network system to predict the behavior of a set of interacting agents.

According to an example embodiment of the present invention, the neural network system comprises an encoder that is configured to convert input data regarding each agent into a one-dimensional agent representation with values representing agent features.

For example, for each of the A agents, a record xᵢ of input data may comprise a history of Fᵢₙ features over Tin discrete time steps, so that the record xᵢ of input data is a tensor xᵢ∈ [symbol] ^{A×T}^{ᵢₙ}^{×F}^{ᵢₙ}. To allow an analysis interactions without having to consider a time dimension, the encoder may map this tensor xᵢ to an agent representation tensor F∈ [symbol] ^{A×d} that contains only a feature vector of dimension d per agent. For example, the encoder may be an already trained neural network, such as a transformer network or a Temporal Convolutional Network. In particular, in the course of the present training method, the encoder may remain frozen.

According to an example embodiment of the present invention, the neural network system also comprises a graph neural network, GNN, that is configured to predict a complete graph of modified agent representations, based on a complete graph of the agent representations. That is, the agent representations are assembled into a complete graph G=(V,E) with the set of nodes V representing agents and the set of edges E representing connections between edges. “Complete” means that every pair of nodes is connected by an edge, i.e., E={(v, u)|v, u∈V}, and every agent is allowed to interact with every other agent.

According to an example embodiment of the present invention, the neural network system further comprises a decoder that is configured to convert the modified agent representations into predicted behavior data ŷᵢ regarding each agent. For example, the predicted behavior data ŷᵢ may be a tensor ŷᵢ | [symbol] ^{A×T}^{ₒᵤₜ}^{×F}^{ₒᵤₜ} that comprises, for each of the A agents, Fₒᵤₜ features for Tₒᵤₜ future time steps. Herein, Tₒᵤₜ may be different from Tᵢₙ, and Fₒᵤₜ may be different from Fᵢₙ. Like the encoder, the decoder may be a neural network that may remain frozen during the present training method.

In the course of the training method, training records xᵢ* of input data regarding each agent are provided. These training records xᵢ* may or may not be annotated with ground truth yᵢ*. I.e., the training may be supervised or unsupervised.

Out of each training record xᵢ*, the encoder generates agent representations Fᵢ. The trained GNN and the decoder process these agent representations Fᵢ into predicted behavior data ŷᵢ regarding each agent. That is, the predicted behavior data ŷᵢ may be written as

ŷᵢ=Decoder(GNN(Fᵢ)).

The output GNN(Fᵢ) is a latent representation of the sought predicted behavior data ŷᵢ, and the decoder transforms this into the predicted behavior data ŷᵢ.

To give the GNN an auxiliary task that encourages consideration of the interactions, from the agent representations Fᵢ, masked agent representations F′ᵢ are determined. To this end, in agent representations Fᵢ for at least two chosen agents, only respective strict subsets of the values of each agent representation are modified. That is, in each agent representation, one or more values remain unmodified. The auxiliary task is to reconstruct, from the masked agent representations F′ᵢ, the original agent representations Fᵢ. That is, information in the agent representations Fᵢ that has been obscured by the masking is to be recovered by exploiting interactions between agents.

This auxiliary task is handled by the combination of the to-be-trained GNN in combination with a helper network. The GNN is able to actually consider interactions between agents and thereby processes the masked agent representations F′ᵢ into interaction representations Gᵢ=GNN(Fᵢ). The helper network determines the reconstructions Fᵢ^{#} of the agent representations Fᵢ from the interaction representations Gᵢ. In particular, the helper network may be configured to work on interaction representations Gᵢ that relate to each agent individually. That is, if there are A agents, the helper network may be invoked A times to process the parts of the interaction representations Gᵢ that relates to the agents 1, . . . , A.

In the following, the reference signs Fᵢ, F′ᵢ and Fᵢ^{#} are used both for a complete tensor of (original/modified/reconstructed) agent representations and for individual agent representations relating to one particular agent, to save another layer of indices.

A predetermined loss function rates
the predicted behavior data ŷᵢ on the one hand, i.e., the performance of the GNN in solving the original task, and
a deviation of the reconstructions Fᵢ^{#} from the agent representations Fᵢ on the other hand, i.e., the performance of the tandem of the GNN and the helper network in solving the auxiliary task.

For example, the loss function may comprise a sum of terms relating to these individual objectives. For the reconstruction term, one example of a loss function that may be used is the Huber loss.

Parameters that characterize the behavior of the GNN and parameters that characterize the behavior of the helper network are optimized towards the goal of improving, when processing further training records xᵢ*, the rating by the loss function. In particular, the mentioned parameters may all be combined into one single parameter vector, and this parameter may be optimized. To this end, for example, a gradient descent method with respect to the rating by the loss function may be used.

It was found that the addition of the auxiliary task to the training process improves the quality of the final predictions ŷᵢ in particular in applications where the interactions between agents are weak but nonetheless important. If the interactions between agents are very strong, it is hardly possible to arrive at a good solution to the original task without considering the interactions. But if the interaction is weak, then the GNN may “limp” to a workable but certainly sub-optimal solution to the original task without considering the interactions.

One example of an application where the interactions may be considered weak is predicting the behavior of traffic participants in traffic situations. In particular, in this application, the interactions may be weak by virtue of being only intermittent. For example, when an ego-vehicle travels along a marked lane that is free to use, what primarily matters is that the ego-vehicle keeps in lane. As long as no other vehicle changes lanes towards the lane travelled by the ego-vehicle, interactions with other vehicles do not necessitate a change of behavior of the ego-vehicle. But if such a lane change happens, or a queue of vehicles begins to form ahead of a red traffic light, the interactions suddenly become relevant.

In another example, a driver of an ego-vehicle may accelerate towards another vehicle in one lane. Eventually, the driver of the ego-vehicle may decide to overtake the other vehicle. In this example, the moment in which the driver decides to overtake the other vehicle marks the beginning of an interaction with the other vehicle because the behavior (here: the slower speed) of the other vehicle made an impact on the decision of the driver to overtake.

It is a particular advantage of modifying only strict subsets of the values of each agent representation (that is, leaving at least some values unchanged) that a loss of information, and a resulting ambiguity of the solution to the auxiliary task, is avoided. For example, if all values in the agent representations regarding two agents P and Q are set to 0, then the two agents become indistinguishable from one another because the graph is complete, and every agent is connected to every other agent. Thus, the GNN and the helper network have no way of knowing that the first agent should be P and the second agent should be Q, and not the other way around. But the loss function will penalize it if P and Q are swapped in the reconstruction.

Therefore, in a particularly advantageous embodiment of the present invention, the strict subsets of modified values of the agent representations Fᵢ are chosen at most so large that the masked agent representations F′ᵢ for the at least two chosen agents are not identical. Thus, it may depend on the concrete agent representations how large the strict subsets of modified values may be. For example, if all values are modified except one value, then the masked agent representations F′ᵢ remain distinguishable if, and only if, this one value is different in the original agent representations Fᵢ.

In another particularly advantageous embodiment of the present invention, the strict subsets of modified values of the agent representations Fᵢ are chosen at least so large that the original values are not derivable from the respective masked agent representation F′ᵢ alone. This ensures that interactions between agents are the only available source for recovering the masked-out information in the masked agent representation F′ᵢ. For some agents, there may be interdependencies of the values in the agent representations Fᵢ such that, if one value is known, the other value is known as well. For example, if a vehicle is presently in a right turn, it cannot be in a left turn at the same time.

Advantageously, according to an example embodiment of the present invention, the modification of values of agent representations Fᵢ comprises overwriting these values with a predetermined value. For example, this predetermined value may be 0. In this manner, the previous information in the value is effectively obliterated.

In a further advantageous embodiment of the present invention, the agent representations Fᵢ that are modified are randomly drawn such that each agent representation Fᵢ is modified with a predetermined probability τ. In this manner, the probability τ becomes a hyperparameter that decides over the volume of the auxiliary task. The agent representations Fᵢ that are not modified remain untouched. The more agent representations Fᵢ are modified, the less information is available in the remaining agent representations Fᵢ, and the more thoroughly the interactions with the remaining agents have to be investigated for a successful reconstruction.

In another advantageous embodiment of the present invention, in each to-be-modified agent representation Fᵢ, the values that are modified are randomly drawn such that each value is modified with a predetermined probability σ. In this manner, this probability σ becomes another hyperparameter that decides over the difficulty of the reconstruction task.

In another advantageous embodiment of the present invention, a multilayer perceptron, MLP, is chosen as the helper network. The output of this network may be in the same space as the input, namely the agent representations Fᵢ regarding a particular agent.

In a further particularly advantageous embodiment of the present invention, the input data xᵢ comprise time series data of the position, trajectory and/or behavior of the agents. The prediction ŷᵢ of the behavior may then be a logical extension of this time series. In particular, new predictions ŷᵢ may always be made based on a certain sliding history of the time series data.

In a further particularly advantageous embodiment of the present invention, the time series data of the position, trajectory and/or behavior of the agents is split into an earlier part that forms training records xᵢ*, and a later part that serves as ground truth yᵢ* for a prediction of the position, trajectory and/or behavior by the neural network system based on the training records. In this manner, it is not necessary to acquire, or manually label, dedicated ground truth data.

As discussed above, in a particularly advantageous embodiment, the agents may be chosen to be traffic participants in a traffic situation. As explained above, the interactions between these agents may be weak and intermittent, but very important to consider when they do occur. Also, the improved accuracy that can be brought about by the present training method is a safety improvement.

In a further particularly advantageous embodiment of the present invention, measurement data that relates to a plurality of agents is acquired by at least one sensor. The measurement data is provided as input data xᵢ to the trained neural network system, such that the neural network system outputs predicted behavior data ŷᵢregarding each agent. By virtue of the improved training, these predictions ŷᵢ are more accurate especially in situations where the correct behavior depends on interactions between agents to a large extent.

In a further particularly advantageous embodiment of the present invention, based on the predicted behavior data ŷᵢ, an actuation signal is determined. A vehicle, a robot, and/or a driving assistance system, is actuated with the actuation signal. In this manner, the probability that the reaction of the respective actuated system to the actuation signal is appropriate in the situation described by the measurement data is improved.

The method may be wholly or partially computer-implemented and embodied in software. The present invention therefore also relates to a computer program with machine-readable instructions that, when executed by one or more computers and/or compute instances, cause the one or more computers and/or compute instances to perform the method. Herein, control units for vehicles or robots and other embedded systems that are able to execute machine-readable instructions are to be regarded as computers as well. Compute instances comprise virtual machines, containers or other execution environments that permit execution of machine-readable instructions in a cloud.

A non-transitory storage medium, and/or a download product, may comprise the computer program. A download product is an electronic product that may be sold online and transferred over a network for immediate fulfilment. One or more computers and/or compute instances may be equipped with said computer program, and/or with said non-transitory storage medium and/or download product.

In the following, the present invention will be described using Figures without any intention to limit the scope of the present invention.

### BRIEF DESCRIPTION OF THE DRAWINGS

FIGS. 1A and 1B show an exemplary embodiment of the method 100 for training the neural network system 1, according to the present invention.

FIG. 2 shows an illustration of the training of the GNN 3 for both a main task and an auxiliary task, according to an example embodiment of the present invention.

FIG. 3 shows an illustration of the auxiliary task of reconstructing agent representations Fᵢ^{#} from masked agent representations F′ᵢ, according to an example embodiment of the present invention.

### DETAILED DESCRIPTION OF EXAMPLE EMBODIMENTS

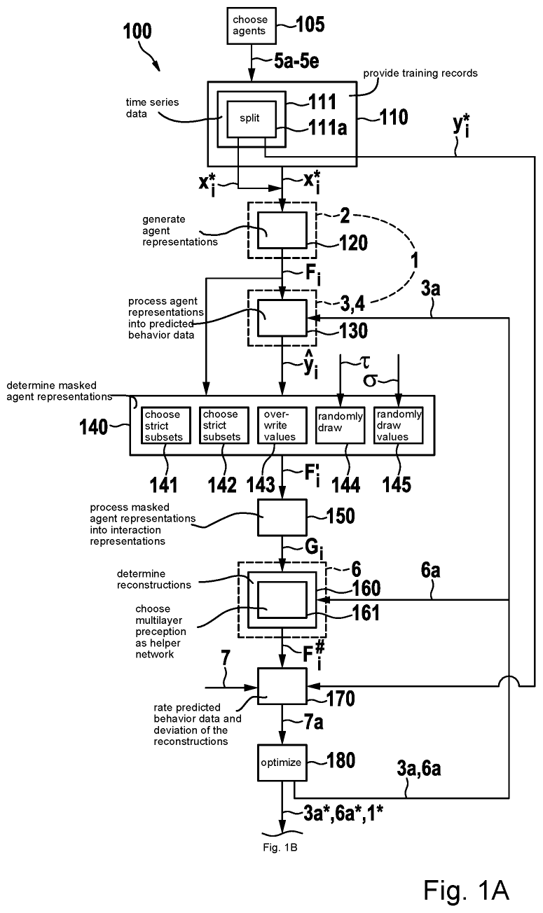

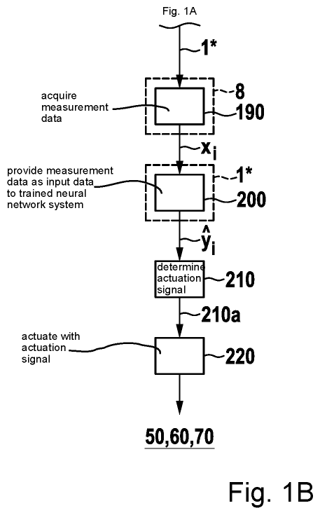

FIGS. 1A and 1B together show a schematic flow chart of an embodiment of the method 100 for training a neural network system 1 to predict the behavior of a set of interacting agents 5a-5e.

In the example shown in FIGS. 1A and 1B, in step 105, the agents 5a-5e are chosen to be traffic participants interacting in a traffic situation.

In step 110, training records xᵢ* of input data regarding each agent are provided.

According to block 111, this input data xᵢ may comprise time series data of the position, trajectory and/or behavior of the agents 5a-5e.

According to block 111a, time series data of the position, trajectory and/or behavior of the agents 5a-5e may be split into an earlier part that forms training records xᵢ*, and a later part that serves as ground truth yᵢ* for a prediction of the position, trajectory and/or behavior by the neural network system 1 based on the training records xᵢ*.

In step 120, out of each training record xᵢ*, the encoder 2 of the neural network system 1 generates agent representations Fᵢ.

In step 130, the to-be-trained GNN 3 and the decoder 4 of the neural network system 1 process the agent representations Fᵢ into predicted behavior data ŷᵢ regarding each agent 5a-5e.

In step 140, masked agent representations F′ᵢ are determine from the agent representations Fᵢ. To this end, in agent representations Fᵢ for at least two chosen agents 5a-5e, only respective strict subsets of the values of each agent representation Fᵢ are modified. The remaining values not in the strict subsets are left untouched.

According to block 141, the strict subsets of modified values of the agent representations Fᵢ may be chosen at most so large that the masked agent representations F′ᵢ for the at least two chosen agents are not identical.

According to block 142, the strict subsets of modified values of the agent representations Fᵢ may be chosen at least so large that the original values are not derivable from the respective masked agent representation F′ᵢ alone.

According to block 143, the modifying of values of agent representations Fᵢ comprises overwriting these values with a predetermined value. In particular, this predetermined value may be 0.

According to block 144, the agent representations Fᵢ that are modified may be randomly drawn such that each agent representation Fᵢ is modified with a predetermined probability τ.

According to block 145, in each to-be-modified agent representation Fᵢ, the values that are modified are randomly drawn such that each value is modified with a predetermined probability σ.

In step 150, the to-be-trained GNN 3 processes the masked agent representations F′ᵢ into interaction representations Gᵢ.

In step 160, a to-be-trained helper network 6 determines reconstructions Fᵢ^{#} of the agent representations Fᵢ from the interaction representations Gᵢ.

According to block 161, a multilayer perceptron, MLP, may be chosen as the helper network.

In step 170, a predetermined loss function 7 rates the predicted behavior data ŷᵢ, as well as a deviation of the reconstructions Fᵢ^{#} from the agent representations Fᵢ. The rating is labelled with the reference sign 7a.

In step 180, parameters 3a that characterize the behavior of the GNN 3 and parameters 6a that characterize the behavior of the helper network 6 are optimized towards the goal of improving, when processing further training records xᵢ*, the rating 7a by the loss function 7. The finally optimized states of the parameters 3a, 6a are labelled with the reference signs 3a* and 6a* respectively. The parameters 3a* also define the finally trained state 1* of the neural network system 1 that comprises the encoder 2, the GNN 3 and the decoder 4. The helper network 6 is only used during the training and does not form part of the final neural network system 1.

In step 190, measurement data that relates to a plurality of agents 5a-5e is acquired by at least one sensor 8.

In step 200, the measurement data is provided as input data xᵢ to the trained neural network system 1*, such that the neural network system 1* outputs predicted behavior data ŷᵢ regarding each agent 5a-5e.

In step 210, based on the predicted behavior data ŷᵢ, an actuation signal 210a is determined.

In step 220, a vehicle 50, a robot 60, and/or a driving assistance system 70, is actuated with the actuation signal 210a.

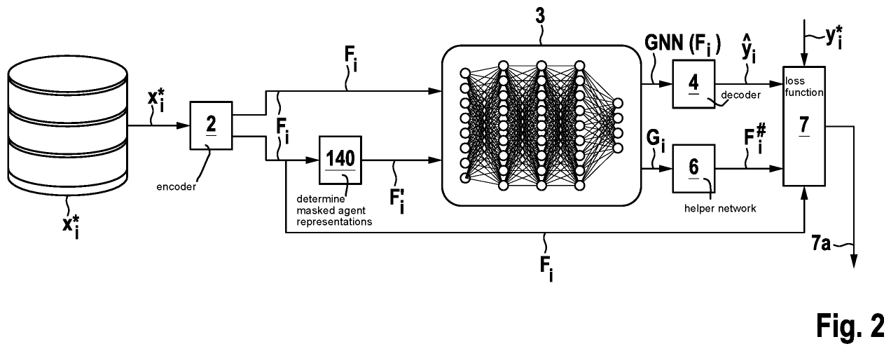

FIG. 2 illustrates how, based on one and the same dataset of training records xᵢ* of input data, one and the same GNN 3 is trained
for the main task of obtaining predicted behavior data ŷᵢ on the one hand, and
for the auxiliary task of reconstructing agent representations Fᵢ^{#} from masked agent representations F′ᵢ on the other hand.

The training records xᵢ* are processed into agent representations Fᵢ by the encoder 2.

For the main task, these agent representations Fᵢ are fed directly into the GNN 3, and the resulting work product GNN(Fᵢ) is decoded by the decoder 4 into the sought predicted behavior data ŷᵢ.

For the auxiliary task, the agent representations Fᵢ are processed into masked agent representations F′ᵢ by step 140 of the method 100. These masked agent representations F′ᵢ are then processed by the GNN 3 into interaction representations Gᵢ. From these interaction representations Gᵢ, the helper network 6 determines the reconstructions Fᵢ^{#} of the agent representations Fᵢ.

In the example shown in FIG. 2, the performance regarding the main task is measured by comparing the predicted behavior data \i with ground truth yᵢ* for the respective training record xᵢ*. The performance regarding the auxiliary task is measured by comparing the reconstructions Fᵢ^{#} to the original agent representations Fᵢ. The results of both comparisons are aggregated in a loss function 7 that delivers a rating 7a. This rating 7a is the feedback for training the GNN 3, as well as the helper network 6 that is used only during training.

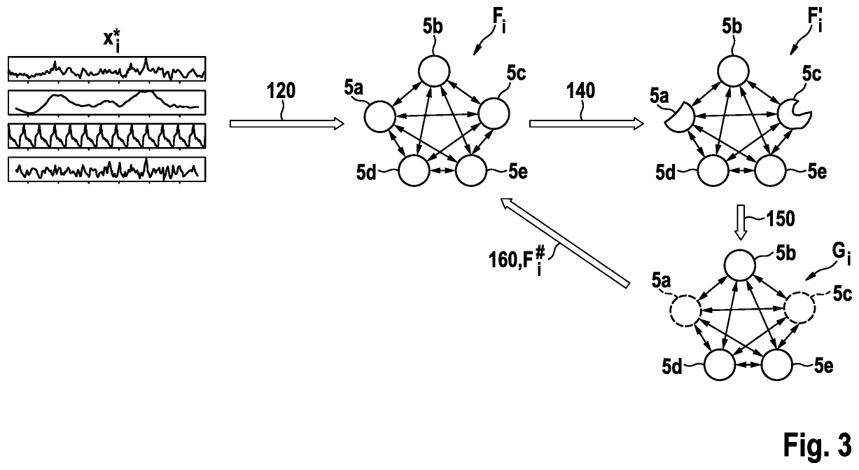

FIG. 3 illustrates the auxiliary task in a little more detail. In the example shown in FIG. 3, the training records xᵢ* comprise time series data of different aspects of the behavior of agents 5a-5e. As discussed before, in step 120 of the method 100, these training records xᵢ* are encoded into agent representations Fᵢ that relate to agents 5a-5e and can be arranged in a complete graph.

In the example shown in FIG. 3, in step 140, the agent representations Fᵢ for the chosen agents 5a and 5c are modified by setting some, but not all, values of these agent representations Fᵢ to 0. This yields masked agent representations F′ᵢ in which the values that relate to the not chosen agents 5b, 5d and 5e are left untouched.

In step 150, the masked agent representations F′ᵢ are processed into interaction representations Gᵢ. From these interaction representations Gᵢ, in step 160, the sought reconstructions Fᵢ^{#} are determined by the helper network 6. The goal of the auxiliary task is that the reconstructions Fᵢ^{#} match the original agent representations Fᵢ.

What is claimed is:

1. A method for training a neural network system to predict a behavior of a set of interacting agents, the neural network system including an encoder configured to convert input data regarding each agent into a one-dimensional agent representation with values representing agent features, a graph neural network (GNN) configured to predict, based on a complete graph of the agent representations, a complete graph of modified agent representations, and a decoder configured to convert the modified agent representations into predicted behavior data regarding each agent, the method comprising the following steps:
providing training records of input data regarding each agent;
generating, from each training record, by the encoder, agent representations;
processing, by the to-be-trained GNN and the decoder, the agent representations into predicted behavior data regarding each agent;
determining, from the agent representations, masked agent representations by modifying, in the agent representations for at least two chosen ones of the agents, only respective strict subsets of values of each agent representation;
processing, by the to-be-trained GNN, the masked agent representations into interaction representations;
determining, by a to-be-trained helper network, from the interaction representations, reconstructions of the agent representations;
rating, using a predetermined loss function, the predicted behavior data, and a deviation of the reconstructions from the agent representations; and
optimizing parameters that characterize the behavior of the GNN and parameters that characterize the behavior of the helper network towards a goal of improving, when processing further training records, the rating by the loss function.

2. The method of claim 1, wherein the strict subsets of modified values of the agent representations are chosen at most so large that the masked agent representations for the at least two chosen agents are not identical.

3. The method of claim 1, wherein the strict subsets of modified values of the agent representations are chosen at least so large that original values are not derivable from the respective masked agent representation alone.

4. The method of claim 1, wherein the modifying of values of agent representations includes overwriting the values with a predetermined value.

5. The method of claim 1, wherein the agent representations that are modified are randomly drawn such that each agent representation is modified with a predetermined probability.

6. The method of claim 1, wherein, in each to-be-modified agent representation, the values that are modified are randomly drawn such that each value is modified with a predetermined probability.

7. The method of claim 1, wherein a multilayer perceptron (MLP) is the helper network.

8. The method of claim 1, wherein the input data include time series data of a position of the agents and/or a trajectory of the agents and/or a behavior of the agents.

9. The method of claim 8, wherein the time series data of the position of the agents and/or the trajectory of the agents and/or the behavior of the agents is split into an earlier part that forms training record, and a later part that serves as ground truth for a prediction of the position and/or the trajectory and/or the behavior by the neural network system based on the training records.

10. The method of claim 1, wherein the agents are traffic participants interacting in a traffic situation.

11. The method of claim 1, further comprising the following steps:
acquiring, by at least one sensor, measurement data that relates to a plurality of agents; and
providing the measurement data as input data to the trained neural network system, such that the neural network system outputs predicted behavior data regarding each agent of the plurality of agents.

12. The method of claim 11, further comprising the following steps:
determining, based on the predicted behavior data regarding each agent of the plurality of agents, an actuation signal; and
actuating, using the actuation signal, a vehicle and/or a robot and/or a driving assistance system.

13. A non-transitory machine-readable data carrier on which is stored a computer program including machine-readable instructions for training a neural network system to predict a behavior of a set of interacting agents, the neural network system including an encoder configured to convert input data regarding each agent into a one-dimensional agent representation with values representing agent features, a graph neural network (GNN) configured to predict, based on a complete graph of the agent representations, a complete graph of modified agent representations, and a decoder configured to convert the modified agent representations into predicted behavior data regarding each agent, the instructions, which executed by one or more computers and/or compute instances, causing the one or more computers and/or compute instances to perform the following steps:
providing training records of input data regarding each agent;
generating, from each training record, by the encoder, agent representations;
processing, by the to-be-trained GNN and the decoder, the agent representations into predicted behavior data regarding each agent;
determining, from the agent representations, masked agent representations by modifying, in the agent representations for at least two chosen ones of the agents, only respective strict subsets of values of each agent representation;
processing, by the to-be-trained GNN, the masked agent representations into interaction representations;
determining, by a to-be-trained helper network, from the interaction representations, reconstructions of the agent representations;
rating, using a predetermined loss function, the predicted behavior data, and a deviation of the reconstructions from the agent representations; and
optimizing parameters that characterize the behavior of the GNN and parameters that characterize the behavior of the helper network towards a goal of improving, when processing further training records, the rating by the loss function.

14. One or more computers and/or compute instances configured to train a neural network system to predict a behavior of a set of interacting agents, the neural network system including an encoder configured to convert input data regarding each agent into a one-dimensional agent representation with values representing agent features, a graph neural network (GNN) configured to predict, based on a complete graph of the agent representations, a complete graph of modified agent representations, and a decoder configured to convert the modified agent representations into predicted behavior data regarding each agent, the one or more computers and/or compute instances configured to:
provide training records of input data regarding each agent;
generate, from each training record, by the encoder, agent representations;
process, by the to-be-trained GNN and the decoder, the agent representations into predicted behavior data regarding each agent;
determine, from the agent representations, masked agent representations by modifying, in the agent representations for at least two chosen ones of the agents, only respective strict subsets of values of each agent representation;
process, by the to-be-trained GNN, the masked agent representations into interaction representations;
determine, by a to-be-trained helper network, from the interaction representations, reconstructions of the agent representations;
rate, using a predetermined loss function, the predicted behavior data, and a deviation of the reconstructions from the agent representations; and
optimize parameters that characterize the behavior of the GNN and parameters that characterize the behavior of the helper network towards a goal of improving, when processing further training records, the rating by the loss function.
